(19) United States
(12) Patent Application Publication
(10) Pub. No.: US 2014/0144833 A1
(43) Pub. Date: May 29, 2014

(54) POLYMER BLEND MEMBRANES

(71) Applicant: Walter Kosar, Pottstown, PA (US)

(72) Inventor: Walter Kosar, Pottstown, PA (US)

(73) Assignee: Arkema Inc., King of Prussia, PA (US)

(21) Appl. No.: 14/233,208

(22) PCT Filed: Aug. 1, 2012
(86) PCT No.: PCT/US12/49091

§ 371 Date: Jan. 16, 2014

Related U.S. Application Data
(60) Provisional application No. 61/515,446, filed on Aug. 5, 2011.

(51) Int. Cl. B01D 71/34

(52) U.S. Cl. CPC B01D 71/34
USPC 210/500.23; 210/500.42; 210/500.28

(57) ABSTRACT

The Invention relates to a membrane formed from a blend of high molecular weight polyvinylidene fluoride (PVDF) (>580,000 Mw) with low molecular weight PVDF (<580,000 Mw). Porous membranes of average pore size from 5 nm to 100 microns made from the blend show improved water permeability compared to membranes formed from a single Mw PVDF.

### FIELD OF THE INVENTION

The Invention relates to a membrane formed from a blend of high molecular weight polyvinylidene fluoride (PVDF) (>580,000 Mw) with low molecular weight PVDF (<580,000 Mw). Porous membranes of average pore size from 5 nm to 100 microns made from the blend show improved water permeability compared to membranes formed from a single Mw PVDF.

### BACKGROUND OF THE INVENTION

There is a growing need to supply fresh water on a global basis to meet the needs of expanding populations. A variety of membrane technologies are actively employed to meet this need. Microfiltration (MF) and ultrafiltration (UF) are used to purify surface waters for drinking, pre-treat brackish and seawater for reverse osmosis, and treat wastewater (especially in membrane bioreactors) prior to discharge into the environment.

Polyvinylidene fluoride (PVDF) is a preferred polymer material for MF and UF membranes due to its excellent chemical resistance, especially to oxidants and halogens used in water purification. PVDF is also convenient to process by solution casting (or melt casting) into porous membranes. PVDF is well established in microfiltration (nominal pore size>0.1 to 0.2 um). The problem with conventional PVDF membranes is that water permeability may be too low for economical use, particularly in developing third world countries where access to clean water is severely limited. As pure water regulations become increasingly stringent, there is a move to require microfiltration membranes to filter below 0.1 um for removal of virus particles. The additional requirement for smaller pore size further reduces water permeability, making the need for a higher permeability PVDF membrane critical to future purification.

It has now been found that formulating a PVDF membrane using a blend of high and low molecular weight PVDF provides increase water flux at the same pore sizes.

### SUMMARY OF THE INVENTION

The invention relates to a porous membrane comprising

a, from 1-99 weight percent of a very high molecular weight (>580,000 Mw, as measured by size exclusion chromatography) polyvinylidene fluoride, and

b) from 99 -1 weight percent of a lower molecular weight PVDF (<580,000 Mw, as measured by size exclusion chromatography),

c) and from 0 to 40 weight percent of other additives,

wherein the pores in the membrane may range from 5 nm up to 100 microns.

### DETAILED DESCRIPTION OF THE INVENTION

The present invention relates the use of a blend of high molecular weight PVDF with low molecular weight PVDF for forming into polymeric membranes. The high molecular weight PVDF has a weight average molecular weight (Mw) of greater than 580,000 g/mole and a number average molecular weight (Mn) of greater than 220,000 g./mole. The low molecular weight PVDF has a weight average molecular weight (Mw) of less than 580,000 g/mole, preferably between 150,000 and 550,000 g/mole and a number average molecular weight (Mn) of less than 220,000 g./mole. The Mw and Mn are measured by size exclusion chromatography. In one embodiment, a single PVDF polymerization can be performed resulting in a bimodal distribution having a high molecular weight and a low molecular weight portion, with molecular weights within the ranges above.

The level of the high molecular weight polymer in the blend is between 1 and 99 percent by weight, preferably from 20 to 80 percent by weight and more preferably from 30 to 70 percent by weight, with the level of the low Mw PVDF at 99-1 weight percent, preferably from 80 to 20 weight percent, and more preferably from 70 to 30 weight percent.

The polyvinylidene fluoride resin composition for both the high and low molecular weight may be the same or different, and may be a homopolymer made by polymerizing vinylidene fluoride (VDF), copolymers, terpolymers and higher polymers of vinylidene fluoride wherein the vinylidene fluoride units comprise greater than 70 percent of the total weight of all the monomer units in the polymer, and more preferably, comprise greater than 75 percent of the total weight of the units. Copolymers, terpolymers and higher polymers of vinylidene fluoride may be made by reacting vinylidene fluoride with one or more monomers from the group consisting of vinyl fluoride, trifluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, hexafluoropropene, trifluoromethyl-methacrylic acid, trifluoromethyl methacrylate, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene. Preferred copolymers or terpolymers are formed with vinyl fluoride, trifluoroethene, tetrafluoroethene (TFE), and hexafluoropropene (HFP) and vinyl acetate. While an all fluoromonomer containing copolymer is preferred, non-fluorinated monomers such as vinyl acetate, methacrylic acid, and acrylic acid, may also be used to form copolymers, at levels of up to 15 weight percent based on the polymer solids.

Preferred copolymers are of VDF comprising from about 71 to about 99 weight percent VDF, and correspondingly from about 1 to about 29 percent TFE; from about 71 to 99 weight percent VDF, and correspondingly from about 1 to 29 percent HFP (such as disclosed in U.S. Pat. No. 3,178,399); and from about 71 to 99 weight percent VDF, and correspondingly from about 1 to 29 weight percent trifluoroethylene.

Preferred terpolymers are the terpolymer of VDF, HFP and TFE, and the terpolymer of VDF, trifluoroethene, and TFE, The especially preferred terpolymers have at least 71 weight percent VDF, and the other comonomers may be present in varying portions, but together they comprise up to 29 weight percent of the terpolymer.

The polyvinylidene fluoride could also be a functionalized PVDF, produced by either copolymerization or by post-polymerization functionalization. Additionally the PVDF could be a graft copolymer, such as, for example, a radiation-grafted maleic anhydride copolymer.

The high and low molecular weight PVDF polymers are admixed together with a solvent to form a blended polymer solution. The PVDF polymers may be blended together followed by dissolution, or the polymers may be separately dissolved in the same or different solvents, and the solvent solutions blended together. Solvents useful in dissolving the solutions of the invention include, but are not limited to N,N-dimethylaeetamide, N,N-diethylacetamide, N-methyl-2-pyrrolidone, N-ethyl-2-pyrrolidone, acetone, dimethyl formamide, tetrahydrofuran, methyl ethyl ketone, tetramethyl urea, dimethyl sulfoxide, triethyl phosphate, N-octyl-pyrrolidone, gamma butyrolacetone, 2-butanone, propylene carbonate, N,N′dimethyl-trimethylene-urea, dimethylcarbonate, diethylcarbonate, and mixtures thereof.

The polymer solution typically has a solids level of from 10 to 30 percent, preferably 15 to 25 and most preferably from 17 to 22 percent. The solution is formed by admixing and optionally heating at a temperature up to 80° C., and typically from 50 to 80° C.

In addition to the PVDF polymers and solvent, other additives may be added to the polymer solution, typically at from 1 to 20 weight percent and more preferably from 5 to 10 weight percent, based on the total solution. Typical additives include, but are not limited to, pore-formers which are typically hydrophilic water extractable compounds such as metallic salts (such as lithium, calcium, magnesium, lithium and zinc salts), alcohols, glycols (such as polyethylene glycol, polypropylene glycol); silica, carbon nanotubes and other nano materials which may or may not be extracted; polyvinylpyrrolidone, ethylene glycol, poly-2-ethyloxazoline, propylene glycol, hydroxyethylcellulose, hydroxymethylcellulose, butylcellosolve, polymethylvinylketone, polymethylmethacrylate, polymethylmethacrylate-co-ethylacrylate, polymethylmethacrylate-co-butylacrylate, polymethymethacrylate-co-butylacrylate-co-hydroxyethylmethacrylate, polymethylmethacrylate-co-butylacrylate-co-methoxypolyethyeleneglycol-methacrylate, polymethylmethacrylate-co-methacrylic acid, polymethylmethacrylate-co-butylacrylate-co-methacrylic acid, polymethylmethacrylate-co-aminopropane sulfonic acid, polymethylmethacrylate-co-aminopropanesulfonic acid sodium salt.

The solution viscosity can be adjusted to obtain the best processing condition. For flat sheet, the overall formulation is adjusted to obtain the best viscosity for a flat web casting. In hollow fiber formation, the process is actually a form of extrusion, and higher viscosities can be beneficial.

The blended PVDF solution is then formed into membranes by typical processes known in the art, to form a flat sheet, supported flat sheet or hollow fiber membrane, such as by solvent cast-non-solvent phase inversion or by thermally induced phase inversion. In one typical process, the blended PVDF solution is solvent cast and drawn down onto a substrate. This membrane may be supported or unsupported, such as being cast onto a porous support web such as a woven or non-woven polyolefin or polyester, or woven polyester braid for supported hollows. The membrane is then formed by a phase separation process, in which the thermodynamics of the cast membrane solution are disrupted, so that the polymer gels and phase separates from the solvent. The change in thermodynamics is often begun by a partial solvent evaporation, and/or exposure of the film to a high humidity environment. The membrane is then placed in a non-solvent for the polymer—such as water, an alcohol, or a mixture thereof—and the solvent removed, leaving a porous membrane. The pore size can be adjusted through the use of additives and the polymer concentration as known in the art. For example high molecular weight additives can lead to large pore sizes, while the use of lithium salt additives can produce small pore sizes.

Pore size of the formed membrane can be between 5 nm and 100 micron. In one embodiment

The blended PVDF membranes of the invention are generally 75 to 200 microns, and preferably from 100 to 150 microns thick.

It has been found that within a given pore size range, blends of high molecular weigth PVDF with lower molecular weight PVDF produces significantly higher water permeability than a porous membrane made from either PVDF seperately.

Furthermore, the blends show reduced loss of flux due to membrane compaction. The membrane of the invention also has reduced membrane fouling compared to membranes prepared from the individual PVDF resin components.

The membrane of the invention was found to have smaller pore sizes 9 based on the bubble point test) with higher water permeability when compared to similar membranes made from the individual PVDF resin components.

The membrane of the invention also has a more uniform pore size distribution as determined by either capillary flow porometry methods, mecury intrusion porosimetry methods, water intrusion porosimetry methods, or microscopy methods, by using the PVDF blends described in claim 1, when compared to membranes prepared from the individual PVDF resin components.

The membranes of the invention may be used in many applications, including but not limited to: water purification, purification of biological fluids, wastewater treatment, osmotic distillation, and process fluid filtration. The membrane of the invention can be used as a hollow fiber of flat sheet membrane

### EXAMPLES

### Example 1

### High Mw/Lower Mw 40:60 Membrane Formulated at 20% Solids in N,N-dimethylacetamide

The following ingredients are weighed out into a mixing vessel and mixed with heating to 55-65° C. on an oil bath for four hours:

| | |
|---|---|
| High Mw PVDF Mw > 600 K, Mn > 280 | 8.0 g |
| PVDF resin Mw 450 - 550 K, Mn 150-200 K | 12.0 g |
| Polyvinylpyrrolidone (K17, Mw 12,000, BASF) | 5.0 g |
| Dimethylacetamide | 75.0 g |

After mixing for four hours, the viscous formulation was removed from heating, sealed, and allowed to cool to ambient temperature. Membranes were cast on HOLLYTEX 3265 fabric support to a wet thickness of ˜370 um (15 mils). The coated support sheet was then immersed in 60% isopropanol/40% water non-solvent bath. After 2 minutes the non-solvent bath, the membrane was transferred to a 45° C. water bath for 30 minutes, followed by transfer to a fresh water bath at ambient temperature for 30 minutes, then transfer to a 100% isopropanol bath for 30 minutes, and a final soak in a fresh water bath for a minimum of one hour. The membranes were then allowed to air dry briefly (15-60 min), followed by drying in an oven at 70 C for 1 hour. The membranes were then ready for testing.

### Example 2

### High Mw/Lower Mw 60:40 Membrane Formulated at 20% Solids in N,N-dimethylacetamide

The following ingredients are weighed out into a mixing vessel and mixed with heating to 55-65 C on an oil bath for four hours:

| | |
|---|---|
| High Mw PVDF Mw > 600 K, Mn > 280 | 12.0 g |
| PVDF resin Mw 450-550 K, Mn 150-200 K | 8.0 g |
| Polyvinylpyrrolidone (K17, Mw 12,000, BASF) | 5.0 g |
| Dimethylacetamide | 75.0 g |

After mixing for four hours, the viscous formulation was removed from heating, sealed, and allowed to cool to ambient temperature. Membranes were cast on HOLLYTEX 3265 fabric support to a wet thickness of ˜370 um (15 mils). The coated support sheet was then immersed in 60% isopropanol/40% water non-solvent bath. After 2 minutes the non-solvent bath, the membrane was transferred to a 45 C water bath for 30 minutes, followed by transfer to a fresh water bath at ambient temperature for 30 minutes, then transfer to a 100% isopropanol bath for 30 minutes, and a final soak in a fresh water bath for a minimum of one hour. The membranes were then allowed to air dry briefly (15-60 min), followed by drying in an oven at 70 C for 1 hour. The membranes were then ready for testing.

### Example 3

### High Mw/Lower Mw 40:60 Membrane Formulated at 20% Solids in N-methylpyrrolidone

The following ingredients are weighed out into a mixing vessel and mixed with heating to 55-65 C on an oil bath for four hours:

| | |
|---|---|
| High Mw PVDF Mw > 600 K, Mn > 280 | 8.0 g |
| PVDF resin Mw 450-550 K, Mn 150-200 K | 12.0 g |
| Polyvinylpyrrolidone (K17, Mw 12,000, BASF) | 5.0 g |
| N-Methylpyrrolidone | 75.0 g |

After mixing for four hours, the viscous formulation was removed from heating, sealed, and allowed to cool to ambient temperature. Membranes were cast on HOLLYTEX 3265 fabric support to a wet thickness of ˜370 um (15 mils). The coated support sheet was then immersed in 60% isopropanol/40% water non-solvent bath. After 2 minutes the non-solvent bath, the membrane was transferred to a 45 C water bath for 30 minutes, followed by transfer to a fresh water bath at ambient temperature for 30 minutes, then transfer to a 100% isopropanol bath for 30 minutes, and a final soak in a fresh water bath for a minimum of one hour. The membranes were then allowed to air dry briefly (15-60 min), followed by drying in an oven at 70 C for 1 hour. The membranes were then ready for testing.

### Example 4

### High Mw/Lower Mw 60:40 Membrane Formulated at 20% Solids in N-methylpyrrolidone

The following ingredients are weighed out into a mixing vessel and mixed with heating to 55-65 C on an oil bath for four hours:

| | |
|---|---|
| High Mw PVDF Mw > 600 K, Mn > 280 | 12.0 g |
| PVDF resin Mw 450-550 K, Mn 150-200 K | 8.0 g |
| Polyvinylpyrrolidone (K17, Mw 12,000, BASF) | 5.0 g |
| N-Methylpyrrolidone | 75.0 g |

After mixing for four hours, the viscous formulation was removed from heating, sealed, and allowed to cool to ambient temperature. Membranes were cast on HOLLYTEX 3265 fabric support to a wet thickness of ˜370 um (15 mils). The coated support sheet was then immersed in 60% isopropanol/40% water non-solvent bath. After 2 minutes the non-solvent bath, the membrane was transferred to a 45 C water bath for 30 minutes, followed by transfer to a fresh water bath at ambient temperature for 30 minutes, then transfer to a 100% isopropanol bath for 30 minutes, and a final soak in a fresh water bath for a minimum of one hour. The membranes were then allowed to air dry briefly (15-60 min), followed by drying in an oven at 70 C for 1 hour. The membranes were then ready for testing.

### Example 5

### Comparative-Single Grade Lower Mw PVDF 20% in N,N-dimethylacetamide

The following ingredients are weighed out into a mixing vessel and mixed with heating to 55-65 C on an oil bath for four hours:

| | |
|---|---|
| PVDF resin Mw 450-550 K, Mn 150-200 K | 20.0 g |
| Polyvinylpyrrolidone (K17, Mw 12,000, BASF) | 5.0 g |
| Dimethylacetamide | 5.0 g |

After mixing for four hours, the viscous formulation was removed from heating, sealed, and allowed to cool to ambient temperature. Membranes were cast on HOLLYTEX 3265 fabric support to a wet thickness of ˜370 um (15 mils). The coated support sheet was then immersed in 60% isopropanol/40% water non-solvent bath. After 2 minutes the non-solvent bath, the membrane was transferred to a 45 C water bath for 30 minutes, followed by transfer to a fresh water bath at ambient temperature for 30 minutes, then transfer to a 100% isopropanol bath for 30 minutes, and a final soak in a fresh water bath for a minimum of one hour. The membranes were then allowed to air dry briefly (15-60 min), followed by drying in an oven at 70 C for 1 hour. The membranes were then ready for testing.

### Example 6

### Comparative-Single Grade Lower Mw PVDF 20% in N-methylpyrrolidone

The following ingredients are weighed out into a mixing vessel and mixed with heating to 55-65 C on an oil bath for four hours:

| | |
|---|---|
| PVDF resin Mw 450-550 K, Mn 150-200 K | 20.0 g |
| Polyvinylpyrrolidone (K17, Mw 12,000, BASF) | 5.0 g |
| N-methylpyrrolidone | 75.0 g |

After mixing for four hours, the viscous formulation was removed from heating, sealed, and allowed to cool to ambient temperature. Membranes were cast on HOLLYTEX 3265 fabric support to a wet thickness of ˜370 um (15 mils). The coated support sheet was then immersed in 60% isopropanol/40% water non-solvent bath. After 2 minutes the non-solvent bath, the membrane was transferred to a 45 C water bath for 30 minutes, followed by transfer to a fresh water bath at ambient temperature for 30 minutes, then transfer to a 100% isopropanol bath for 30 minutes, and a final soak in a fresh water bath for a minimum of one hour. The membranes were then allowed to air dry briefly (15-60 min), followed by drying in an oven at 70 C for 1 hour. The membranes were then ready for testing.

### Example 7

### Comparative-Single Grade High Mw PVDF 20% in N,N-dimethylacetamide

The following ingredients are weighed out into a mixing vessel and mixed with heating to 55-65 C on an oil bath for four hours:

| | |
|---|---|
| High Mw PVDF Mw > 600 K, Mn > 280 | 20.0 g |
| Polyvinylpyrrolidone (K17, Mw 12,000, BASF) | 5.0 g |
| Dimethylacetamide | 75.0 g |

After mixing for four hours, the viscous formulation was removed from heating, sealed, and allowed to cool to ambient temperature. Due to the very high molecular weight of this grade, it was very difficult to prepare formulations at higher solids content due the resulting high viscosity. Membranes were cast on HOLLYTEX 3265 fabric support to a wet thickness of ˜370 um (15 mils). The coated support sheet was then immersed in 60% isopropanol/40% water non-solvent bath. After 2 minutes the non-solvent bath, the membrane was transferred to a 45 C water bath for 30 minutes, followed by transfer to a fresh water bath at ambient temperature for 30 minutes, then transfer to a 100% isopropanol bath for 30 minutes, and a final soak in a fresh water bath for a minimum of one hour. The membranes were then allowed to air dry briefly (15-60 min), followed by drying in an oven at 70 C for 1 hour. The membranes were then ready for testing.

### Membrane Testing: Capillary Flow Porometry

The pore size of the membranes produced in examples 1-6 was determined using a PMI capillary flow porometer and using a perfluoropolyether wetting liquid (Galwick). This method is known to those skilled in the practice of membrane science. Capillary flow porometer will give the bubble point (largest pore diameter) and mean pore diameter. The bubble point diameter is a well known metric in the membrane industry to determine particle size cut-off for membranes. Here, it is used as a general guide to compare different membranes in their cut-off size ranges.

| | Bubble point | Mean Pore |
|---|---|---|
| Membrane | diameter(m) | diameter (um) |
| Example 1 | 0.137 | 0.797 |
| Example 2 | 0.118 | 0.0439 |
| Example 3 | 0.120 | 0.0679 |
| Example 4 | 0.118 | 0.0439 |
| Example 5 | 0.184 | 0.0653 |
| Example 6 | 0.172 | 0.0701 |
| Example 7 | 0.208 | 0.111 |

This data shows that the high Mw/low Mw PVDF blends produce membranes with a smaller bubble point than the comparative examples.

### Water Permeation Testing

We tested membranes by cross flow water filtration using the following prodedure. Membranes were soaked in isopropanol for 2 minutes followed by rinsing in deionized water. The membranes were then installed in Sepa CF 042 cross flow cells (Sterlitech) and cross flow filtration was begun. The membranes were compacted by filtering for 16 hours at 6 psig. The pressure was then dropped to 3 psi and filtration continued for six hours. The filtration during the final hour was collected and used to compare filtration peformance for all membranes. The table below gives the filtration results expressed in liter/m2-hr-bar (lmhb). The bubble point data are also shown for comparison.

| | Cross Flow | Bubble Point |
|---|---|---|
| Membrane | Permeability (lmhb) | Diamerter (um) |
| Example 1 | 1005 | 0.137 |
| Example 2 | 1230 | 0.118 |
| Example 3 | 706 | 0.120 |
| Example 4 | 1021 | 0.118 |
| Example 5 | 261 | 0.184 |
| Example 6 | 227 | 0.172 |
| Example 7 | 478 | 0.209 |

The data clearly show much higher water permeability for the blended membranes compared to the individual PVDF resin grades. This confirms the benefit of using these blends over single grades. The data also show tighter pore size for the blends, which is very implies these blends may be very suitable to make tight pore ultrafiltration membranes having very high water permeability.

The examples shown are not meant to be all-inclusive or exclusionary of other formulations. Significant extensions to this technology include use of lower Mw PVDF grades (Mw<450, Mn<150) to blend; use of PVDF copolymers, use of highly branched PVDF, use of different grades of polyvinylpyrrolidone, use of a variety of different pore forming additives, use of selected non-solvents in the formulation, use of other co-solvents in the formulations, use of other non-solvent baths, casting at different temperatures, use of pre-evaporation of solvent prior to immersion in non-solvent bath, exposure to humidified air before immersion in non-solvent bath, and casting in the form of a hollow fiber with all the standard variables used in hollow fiber casting.

1. A porous membrane comprising
a. from 1-99 weight percent of a very high molecular weight (>580,000 Mw, as measured by size exclusion chromatography) polyvinylidene fluoride, and
b) from 99 -1 weight percent of a lower molecular weight PVDF (<580,000 Mw, as measured by size exclusion chromatography),
c) and from 0 to 40 weight percent of other additives,
wherein the pores in the membrane may range from 5 nm up to 100 microns.

2. The membrane of claim 1 wherein the lower molecular weight PVDF has a weight average molecular weight (Mw) between 450,000 and 550,000 as measured by size exclusion chromatography.

3. The membrane of claim 1 where the lower molecular weight PVDF has a weight average molecular weight (Mw) between 350,000 and 450,000 as measured by size exclusion chromatography.

4. The membrane of claim I where the lower molecular weight PVDF has a weight average molecular weight (Mw) between 250,000 and 350,000 as measured by size exclusion chromatography.

5. The membrane of claim 1 where the lower molecular weight PVDF has a weight average molecular weight (Mw) between 150,000 and 250,000 as measured by size exclusion chromatography.

6. The composition of claim 1 wherein said additives are selected from the group consisting of polyvinylpyrrolidone, polyethylene glycol, ethylene glycol, poly-2-ethyloxazoline, propylene glycol, hydroxyethylcellulose, hdroxymethylcellulose, butylcellosolve, lithium salts, calcium salts, sodium salts, magnesium salts, polymethylvinylketone, polymethylmethacrylate, polymethylmethacrylate-co-ethylacrylate, polymethylmethacrylate-co-butylacrylate, polymethymethacrylate-co-butylacrylate-co-hydroxyethylmethacrylate, polymethylmethacrylate-co-butylacrylate-co-methoxypolyethyeleneglycol-methacrylate, polymethylmethacrylate-co-methacrylic acid, polymethylmethacrylate-co-butylacrylate-co-methacrylic acid, polymethylmethacrylate-co-aminopropane sulfonic acid, polymethylmethacrylate-co-aminopropanesulfonic acid sodium salt.

7. The membrane of claim 1, wherein the water permeability of said porous membrane has a higher water permeability than a porous membrane made from either PVDF seperately.

8. The membrane of claim 1, wherein membrane fouling is reduced compared to membranes prepared from the individual PVDF resin components.

9. The membrane of claim 1, wherein said membrane comprises smaller cut-off pore sizes with higher water permeability when compared to similar membranes made from the individual PVDF resin components.

10. The membrane of claim 1, wherein said membrane has a more uniform. pore size distribution as determined by either capillary flow porometry methods, mecury intrusion porosimetry methods, water intrusion porosimetry methods, or microscopy methods, by using the PVDF blends described in claim 1, when compared to membranes prepared from the individual PVDF resin components.

11. A membrane described in claim 1 that is a hollow fiber.

12. A membrane described in claim 1 that is a flat sheet.
